(19) United States
(12) Patent Application Publication
(10) Pub. No.: US 2014/0205705 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/953,987

(22) Filed: Jul. 30, 2013

(30) Foreign Application Priority Data
Jan. 24, 2013 (TW) 102102730

(51) Int. Cl. B30B 3/00; B29D 99/00

(52) U.S. Cl. CPC B30B 3/005; B29D 99/0032
USPC 425/471; 156/446; 156/187

(57) ABSTRACT

A molding roller includes a cylindrical main body and a flexible molding film. The main body has a circumferential surface. The molding film is wound around and fixed to the circumferential surface. The molding film has a molding surface opposite to the main body. The molding surface has a number of molding patterns. The molding film is made of flexible polymer material, and the flexible polymer material is obtained through the polymerization of polydimethylsiloxane and hard chain additive. The invention further relates to an apparatus and provides a method for manufacturing the molding roller.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metallic roller. The metallic roller has a circumferential surface including molding patterns for forming the micro structures. The molding pattern is formed by a laser knife. However, it is difficult to machine the molding patterns on a curved surface of the metallic roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

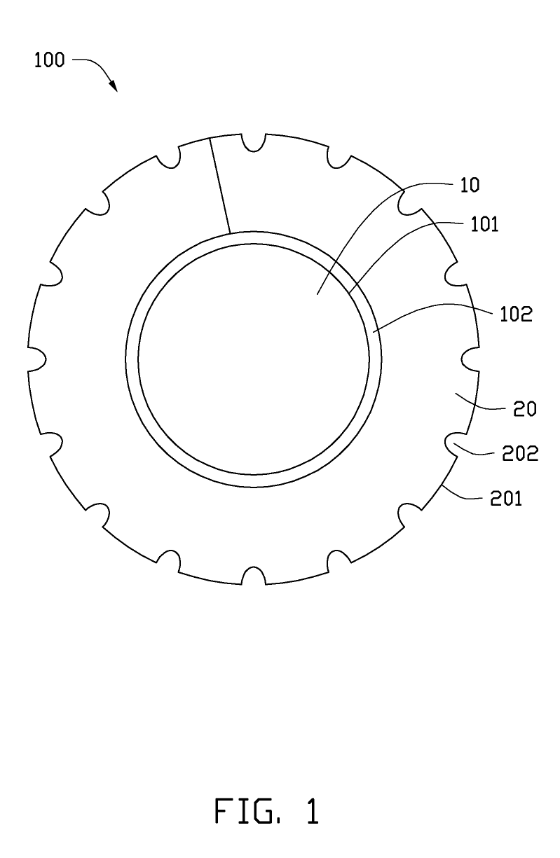

FIG. 1 illustrates a molding roller 100 in accordance to a first exemplary embodiment. The molding roller 100 includes a cylindrical main body 10 and a ring-shaped molding film 20. The main body 10 includes a circumferential surface 101, and can be made of stainless steel or other metals. The circumferential surface 101 is coated with an adhesive glue 102.

The molding film 20 is wound around and fixed to the circumferential surface 101 via the adhesive glue 102. The molding film 20 includes a molding surface 201 opposite to the main body 10. The molding surface 201 includes a number of molding patterns 202. In the first embodiment, the molding patterns 202 are micro grooves. In other embodiments, the molding patterns 202 can be micro-dots or micro striped protrusions.

The molding film 20 is made of flexible polymer material. The flexible polymer material is obtained through polymerization of polydimethylsiloxane (PDMS) and hard chain additive. In the first embodiment, the hard chain additive is poly(siloxane-urethane) (PSiU) which is obtained through polymerization of 4,4′-diphenylmethane diisocyanate (MDI) and 1,4-butanediol (1,4-BD). Because the polymer material is easily separated from the optical films, the molding film 20 is easily separated from optical films, and the quality of the optical films can be greatly improved.

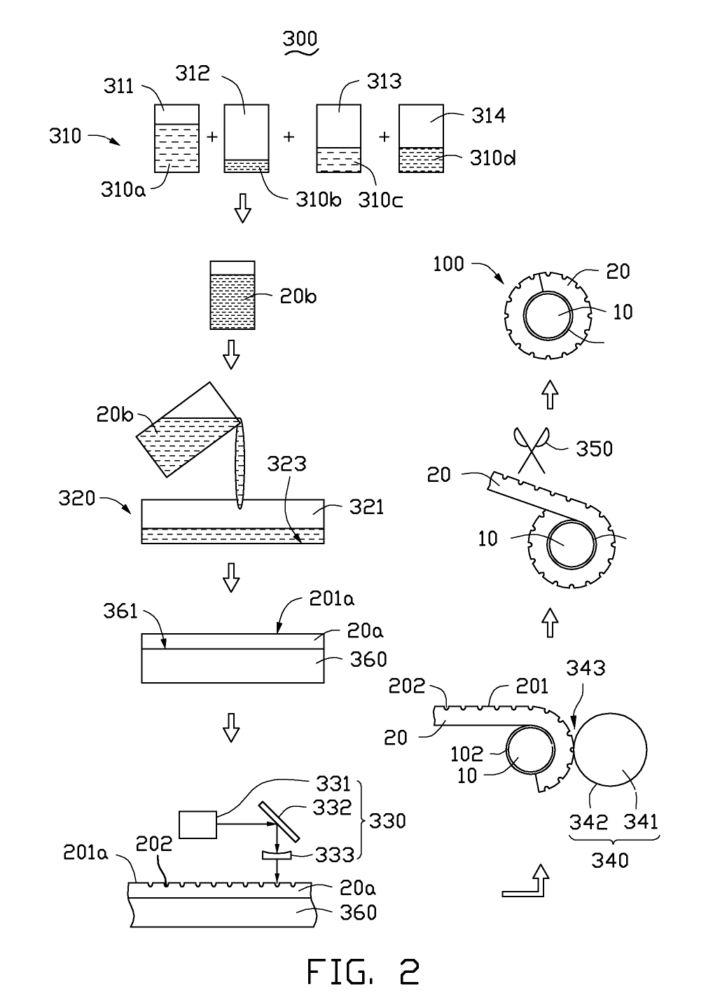

FIG. 2 illustrates an apparatus 300 for manufacturing the molding roller 100, according to a second exemplary embodiment. The apparatus 300 includes a mixing assembly 310, a curing device 320, a loading plate 360, a processing device 330, a mounting device 340, and a cutting device 350.

The mixing assembly 310 is used for mixing the PDMS 310a and the hard chain additive 310b according the hardness requirement, and thus the PDMS 310a is polymerized with the hard chain additive 310b to obtain the molding film material 20b. The hard chain additive 310b is PSiU, and is obtained through the polymerization of MDI and 1,4-BD.

The mixing assembly 310 includes a first container 311, a second container 312, a third container 313, and a fourth container 314. The first container 311 receives the PDMS 310a. The second container 312 receives the hard chain additive 310b. The third container 313 receives a solvent 310c consisting of N,N-dimethylformamide (DMF) and tetrahydrofuran (THF). The fourth container 314 receives a catalyst 310d. In the second embodiment, the catalyst 310d is di-n-butyltin dilaurate (T-12), and the weight of the catalyst 310d is 0.02% of the sum of the weight of the PDMS 310a and the weight of the hard chain additive 310b.

In particular, the PDMS 310a and the hard chain additive 310b are mixed according the hardness requirement to obtain a mixed solute, the mixed solute is poured into the solvent 310c, the mixed solute and the solvent are stirred at a predetermined temperature (such as 55° C.) for a predetermined period (such as 2 hours), and thus the mixed solute is absolutely dissolved in the solvent 310c to obtain a reaction liquid.

Then the catalyst 310d is added into the reaction liquid, and the catalyst 310d promotes the polymerization of the PDMS and the hard chain additive, and thus the molding film material is obtained. In this embodiment, the first container 311, the second container 312, the third container 313, and the fourth container 314 are measuring glasses.

The curing device 320 is used for curing the molding film material 20b to obtain a preprocessed molding film 20a. In this embodiment, the curing device 320 includes a cubic molding chamber 321. At least one inner surface of the molding chamber 321 is a mirror surface 323 for molding the preprocessed molding film 20a. In the second embodiment, the mirror surface 323 is a bottom surface of the molding chamber 321. A temperature of the molding chamber 321 is lower than a curing temperature of a molding film material 20b. The molding film material 20b is poured into the molding chamber 321 for a predetermined period until the molding film material 20b is cured to be a stripe-shaped preprocessed molding film 20a. The preprocessed molding film 20a has the preprocessed molding surface 201a in contact with the mirror surface 305.

The loading plate 360 is used for loading the preprocessed molding film 20a, and the preprocessed molding surface 201a is opposite to the loading plate 360. The loading plate 360 has a planar loading surface 361. Two opposite ends of the preprocessed molding film 20a are fixed to the planar loading surface 361 through an adhesive glue (not shown) or other fixing means.

The processing device 330 is used for forming a number of molding patterns 202 on the preprocessed molding surface 201a, and thus the molding film 20 and the molding surface 201 are obtained. In the second embodiment, the processing device 330 includes a laser emitter 331, a reflector 332, and a converging lens 333. The laser emitter 331 is used for emitting laser rays. The transmitting direction of the laser rays is substantially parallel to the preprocessed molding surface 201a. The reflector 332 is used for changing the transmitting direction of the laser rays and reflecting the laser rays to the converging lens 333. The converging lens 333 converges the laser rays to the preprocessed molding surface 201a. In other embodiments, the reflector 332 and the converging lens 333 can be omitted, and the transmitting direction of the laser rays should be substantially perpendicular to the preprocessed molding surface 201 a. In other embodiments, if the impression patterns are V-shaped grooves, and the processing device 330 can include a diamond knife having a V-shaped blade.

The mounting device 340 is used for mounting the molding film 20 on the circumferential surface 101 of the main body 10, and includes an auxiliary roller 341 having a smooth rolling surface 342. The auxiliary roller 341 is spaced at a predetermined distance from the main body 10 to form a molding channel 343. The auxiliary roller 341 and the main body 10 are rotated in reverse directions. The circumferential surface 101 of the main body 10 is coated with the adhesive glue 102. An end of the molding film 20 is adhered on the circumferential surface 101, then the main body 10 and the auxiliary roller 341 are rotated to make the molding film 20 passing through the molding channel 343, and thus the molding film 20 is wound around the circumferential surface 101 via the adhesive glue 102.

The cutting device 350 is used for cutting the molding film 20.

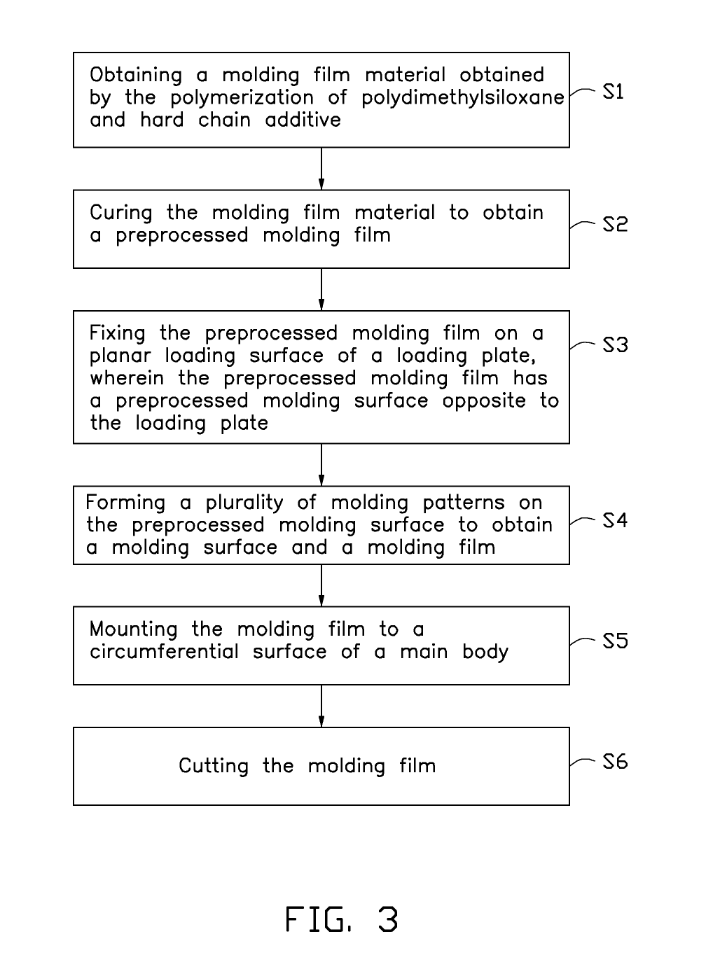

FIG. 3 illustrates a method for manufacturing the molding roller 100 using the apparatus 300, according to a third exemplary embodiment. The method includes the following steps.

In step S1, the PDMS 310a and the hard chain additive 310b are mixed using the mixing assembly 300 according to the hardness requirement, then the PDMS 310a is polymerized with the hard chain additive 310b to obtain the molding film material 20b.

In step S2, the molding film material 20b is poured into the curing device 320, and the temperature of the curing device 320 is lower than the curing temperature of the molding film material 20b, and thus the preprocessed molding film 20a is obtained after a predetermined period. In the third embodiment, the curing device 320 includes the molding chamber 321, the bottom inner surface of the molding chamber 321 is the mirror surface 323 for molding the preprocessed molding surface 201a of the preprocessed molding film 20a.

In step S3, the preprocessed molding film 20a is fixed to the planar loading surface 361 of the loading plate 360, and the preprocessed molding surface 201a is opposite to the loading plate 360.

In step S4, the molding patterns 202 are formed on the preprocessed molding surface 201a using the processing device 330, and thus the molding surface 201 and the molding film 20 are obtained.

In step S5, the molding film 20 is separated from the loading plate 360, and is wound around the circumferential surface 101 of the main body 10.

In step S6, the molding film 20 is cut.

In other embodiments, the order of the step S5 and the step S6 also can be interchanged.

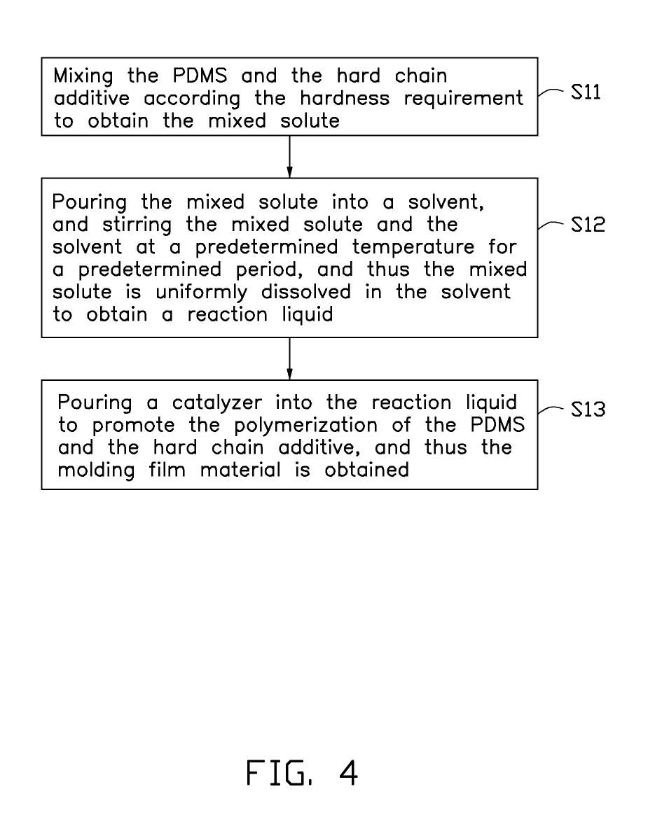

FIG. 4 illustrates that the step Si further includes the following sub-steps.

In step S11, the PDMS 310a and the hard chain additive 310b are mixed according the hardness requirement to obtain the mixed solute. In the third embodiment, the hard chain additive 310b is PSiU obtained through the polymerization of MDI and 1,4-BD.

In step S12, the mixed solute is poured into the solvent 310c consisting of DMF and THF, then the mixed solute and the solvent 310 are stirred at the predetermined temperature (such as 55° C.) for the predetermined period (such as 2 hours), and thus the mixed solute is uniformly dissolved in the solvent 310 to obtain a reaction liquid.

In step S13, the catalyst (such as T-12) 310d is poured into the reaction liquid to promote the polymerization of the PDMS 310a and the hard chain additive 310b, and thus the molding film material 20b is obtained.

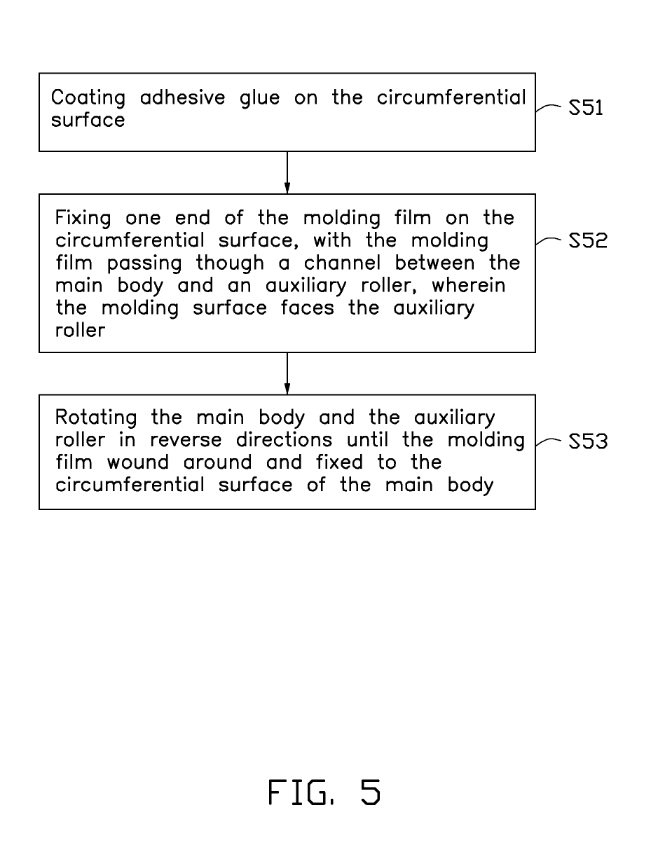

FIG. 5 illustrates that the step S5 further includes the following sub-steps.

In step S51, the circumferential surface 101 is coated with the adhesive glue 102.

In step S52, an end of the molding film 20 is adhered to the circumferential surface 101, and the molding surface 201 faces the auxiliary roller 341.

In step S53, the main body 10 and the auxiliary roller 341 are rotated to make the molding film 20 passing through the molding channel 343 until the molding film 20 is wound around the circumferential surface 101.

By employing the apparatus 300 and the above described method, it is easier for the processing device 330 to machine the molding patterns 202 on the planar preprocessed molding surface 201a relative to on a curved surface. Therefore, the machining efficiency is improved.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a circumferential surface; and
a flexible molding film wound around and fixed to the circumferential surface, the molding film having a molding surface opposite to the main body, and the molding surface having a plurality of molding patterns;
wherein the molding film is made of flexible polymer material, and the flexible polymer material is obtained through the polymerization of polydimethylsiloxane and hard chain additive.

2. The molding roller of claim 1, wherein the hard chain additive is poly(siloxane-urethane) obtained through the polymerization of 4,4′-diphenylmethane diisocyanate and 1,4-butanediol.

3. The molding roller of claim 1, wherein the circumferential surface is coated with an adhesive glue, and the molding film is fixed to the circumferential surface through the adhesive glue.

4. The molding roller of claim 1, wherein the main body is made of metal.

5. An apparatus for manufacturing a molding roller, comprising:
a mixing assembly configured for obtain a molding film material by polymerization of polydimethylsiloxane and hard chain additive;
a curing device configured for curing the molding film material to obtain a preprocessed molding film, the curing device comprising a molding chamber with at least one mirror surface for molding the preprocessed molding film, wherein a temperature of the molding chamber is lower than a curing temperature of the molding film material;
a loading plate having a planar loading surface for fixing the preprocessed molding film, wherein the preprocessed molding film has a preprocessed molding surface opposite to the loading plate;
a processing device configured for forming a plurality of molding patterns on the preprocessed molding surface to obtain a molding surface and a molding film;
a mounting device configured for mounting the molding film to a circumferential surface of a main body, wherein the molding patterns is opposite to the main body; and
a cutting device for cutting the molding film.

6. The apparatus of claim 5, wherein the mixing assembly comprises a first container, a second container, a third container, and a fourth container, the first container receives the polydimethylsiloxane, the second container receives the hard chain additive, the third container receives a solvent, the fourth container receives a catalyst.

7. The apparatus of claim 6, wherein the hard chain additive is poly(siloxane-urethane) obtained through the polymerization of 4,4′-diphenylmethane diisocyanate and 1,4-butanediol.

8. The apparatus of claim 7, wherein the solvent consists of N,N-dimethylformamide and tetrahydrofuran, the catalyst is di-n-butyltin dilaurate.

9. The apparatus of claim 8, wherein the weight of the catalyst is 0.02% of the sum of the weight of the polydimethylsiloxane and the weight of the hard chain additive.

10. The apparatus of claim 5, wherein the processing device comprises a laser emitter, a reflector, and a converging lens, the laser emitter emits laser rays, the transmitting direction of the laser rays is substantially parallel to the preprocessed molding surface, the reflector changes the transmitting direction of the laser rays and reflecting the laser rays to the converging lens, the converging lens converges the laser rays to the preprocessed molding surface.

11. The apparatus of claim 5, wherein the mounting device comprises an auxiliary roller spaced a predetermined distance from the main body to form a channel between the auxiliary roller and the main body, the main body and the auxiliary roller rotate towards reverse directions, the circumferential surface is coated with an adhesive glue.

12. A method for manufacturing a molding roller, comprising:
obtaining a molding film material by polymerization of polydimethylsiloxane and hard chain additive;
curing the molding film material to obtain a stripe-shaped preprocessed molding film;
fixing the preprocessed molding film on a planar loading surface of a loading plate, wherein the preprocessed molding film has a preprocessed molding surface opposite to the loading plate;
forming a plurality of molding patterns on the preprocessed molding surface to obtain a molding surface and a molding film;
mounting the molding film to a circumferential surface of a main body, wherein the molding patterns is opposite to the main body; and
cutting the molding film.

13. The method of claim 12, wherein the step of obtaining a molding film material by polymerization of polydimethylsiloxane and hard chain additive of further comprises:
mixing the PDMS and the hard chain additive according the hardness requirement to obtain the mixed solute;
pouring the mixed solute into a solvent, and stirring the mixed solute and the solvent at a predetermined temperature for a predetermined period, and thus the mixed solute is uniformly dissolved in the solvent to obtain a reaction liquid; and
pouring a catalyst into the reaction liquid to promote the polymerization of the PDMS and the hard chain additive, and thus the molding film material is obtained.

14. The method of claim 12, wherein the step of curing the molding film material to obtain a preprocessed molding film further comprises:
providing a molding chamber with at least one mirror surface for molding the preprocessed molding film, and a temperature of the molding chamber is lower than a curing temperature of the molding film material; and
pouring the molding film material into the molding chamber, and waiting for a predetermined period until the molding film material is cured.

15. The method of claim 12, wherein the step of mounting the molding film on a circumferential surface of a main body further comprises:
applying adhesive glue on the circumferential surface of the main body;
fixing one end of the molding film on the circumferential surface, with the molding film passing though a molding channel between the main body and an auxiliary roller, wherein the molding surface faces the auxiliary roller; and
rotating the main body and the auxiliary roller in reverse directions until the molding film wound around and fixed to the circumferential surface of the main body.

16. The method of claim 12, wherein the hard chain additive is poly(siloxane-urethane) obtained through the polymerization of 4,4′-diphenylmethane diisocyanate and 1,4-butanediol.

17. The method of claim 16, wherein the solvent is consisted of N,N-dimethylformamide and tetrahydrofuran, the catalyst is di-n-butyltin dilaurate.

18. The method of claim 17, wherein the weight of the catalyst is 0.02% of the sum of the weight of the polydimethylsiloxane and the weight of the hard chain additive.
